(19) United States
(12) Patent Application Publication
(10) Pub. No.: US 2023/0281870 A1
(43) Pub. Date: Sep. 7, 2023

(54) STORAGE MEDIUM STORING COMPUTER PROGRAM AND POINT CLOUD PROCESSING APPARATUS

(71) Applicant: BROTHER KOGYO KABUSHIKI KAISHA, Nagoya (JP)

(72) Inventor: Masaya TAKASU, Tokai (JP)

(21) Appl. No.: 18/149,191

(22) Filed: Jan. 3, 2023

(30) Foreign Application Priority Data
Mar. 3, 2022 (JP) 2022-032952

(51) Int. Cl. G06T 7/73; B25J 9/16

(52) U.S. Cl. CPC G06T 7/75; B25J 9/1697; G06T 2207/10028

(57) ABSTRACT

A set of program instructions causes a computer to perform: selecting a point pair of a first point and a second point from a three-dimensional point cloud including points indicating a surface of a three-dimensional object; determining a first normal vector at the first point by using points included in a first area; determining a second normal vector at the first point by using points included in a second area; determining a third normal vector at the second point by using points included in a third area; determining a fourth normal vector at the second point by using points included in a fourth area; calculating a feature indicating a geometric feature by using the first normal vector, the second normal vector, the third normal vector, and the fourth normal vector; and performing a particular process by using the feature.

### REFERENCE TO RELATED APPLICATIONS

This application claims priority from Japanese Patent Application No. 2022-032952 filed on Mar. 3, 2022. The entire content of the priority application is incorporated herein by reference.

### BACKGROUND ART

Techniques have been proposed for estimating a position and an orientation of a three-dimensional object by using three-dimensional point clouds.

### DESCRIPTION

For example, a point pair feature for point pairs selected from a model point cloud is calculated for each point pair. A plurality of key points are selected from the model point cloud. The point pair feature for point pairs in a scene point cloud is calculated. Point pairs with point pair features similar to the point pair features for a plurality of key points are searched for. Coordinate transformation parameters are determined for each of the searched point pairs, and the number of counts is determined for each orientation indicated by the coordinate transformation parameters. A plurality of candidate orientations are selected in descending order of the number of counts. The orientation that maximizes the degree of matching between the model point cloud and the scene point cloud is determined as the final orientation.

Three-dimensional point clouds may be used in a variety of processes, such as determination of a position and an orientation. However, the processing of three-dimensional point clouds is not easy, and there is room for improvement.

In view of the foregoing, this specification discloses techniques for processing three-dimensional point clouds.

According to one aspect, this specification discloses a non-transitory computer-readable storage medium storing a set of program instructions for a computer. The set of program instructions, when executed by a controller of the computer, causes the computer to perform: selecting a point pair of a first point and a second point from a three-dimensional point cloud including a plurality of points indicating a surface of a three-dimensional object, the first point and the second point being separated by a distance within a particular distance range; determining a first normal vector at the first point by using a plurality of points included in a first area of which a distance from the first point is within a first distance range; determining a second normal vector at the first point by using a plurality of points included in a second area of which a distance from the first point is within a second distance range, the second distance range including a distance greater than an upper limit of the first distance range; determining a third normal vector at the second point by using a plurality of points included in a third area of which a distance from the second point is within a third distance range; determining a fourth normal vector at the second point by using a plurality of points included in a fourth area of which a distance from the second point is within a fourth distance range, the fourth distance range including a distance greater than an upper limit of the third distance range; calculating a feature indicating a geometric feature by using the first normal vector, the second normal vector, the third normal vector, and the fourth normal vector; and performing a particular process by using the feature.

According to this configuration, an appropriate feature indicating a geometric feature is calculated by using the first point, the first normal vector and the second normal vector at the first point, the second point, the third normal vector and the fourth normal vector at the second point. Further, the particular process is appropriately executed by using the calculated feature.

According to another aspect, this specification also discloses a non-transitory computer-readable storage medium storing a set of program instructions for a computer. The set of program instructions, when executed by a controller of the computer, causes the computer to perform: selecting a point pair of a first point and a second point from a three-dimensional point cloud including a plurality of points indicating a surface of a three-dimensional object, the first point and the second point being separated by a distance within a particular distance range; determining a first normal vector at the first point by using a plurality of points included in a first area of which a distance from the first point is within a first distance range; and determining a local coordinate system having a first axis, a second axis, and a third axis perpendicular to one another by using the first point, the second point, and the first normal vector, the determining the local coordinate system including: calculating a first vector defining the first axis, the first vector having a start point that is the first point and an end point located on a straight line passing through the first point and the second point; calculating a third vector defining the third axis, the third vector being a cross product of the first normal vector and the first vector or a cross product of the second normal vector and the first vector; and calculating a second vector defining the second axis, the second vector being a cross product of the first vector and the third vector.

According to this configuration, an appropriate local coordinate system is determined by using the first point, the second point, and the first normal vector.

The technology disclosed in this specification may be implemented in various modes, and may be realized in forms such as a point cloud processing method and a point cloud processing apparatus, a local coordinate system determination method and a local coordinate system determination apparatus, a computer program for realizing the functions of those methods or apparatuses, a storage medium (for example, a non-transitory storage medium) storing the computer program, and so on.

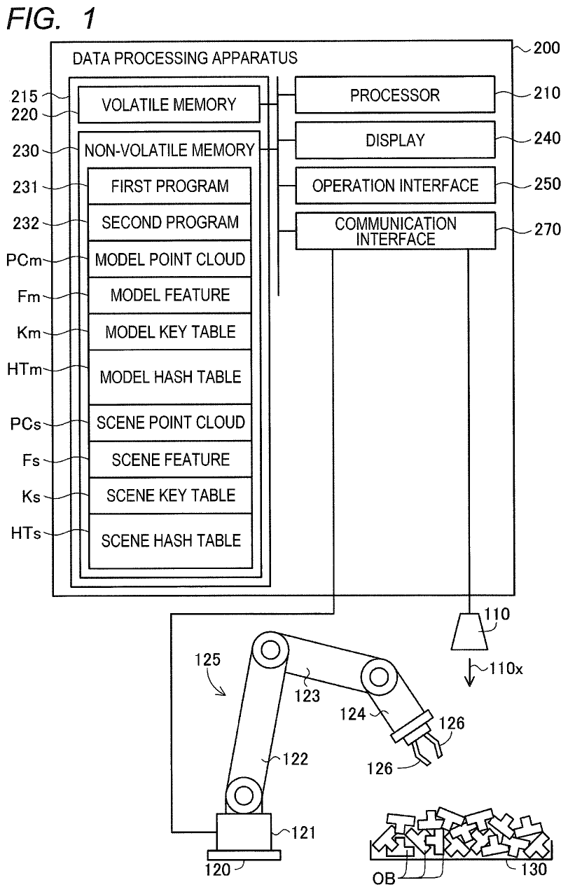

FIG. 1 is a schematic diagram showing a data processing apparatus.

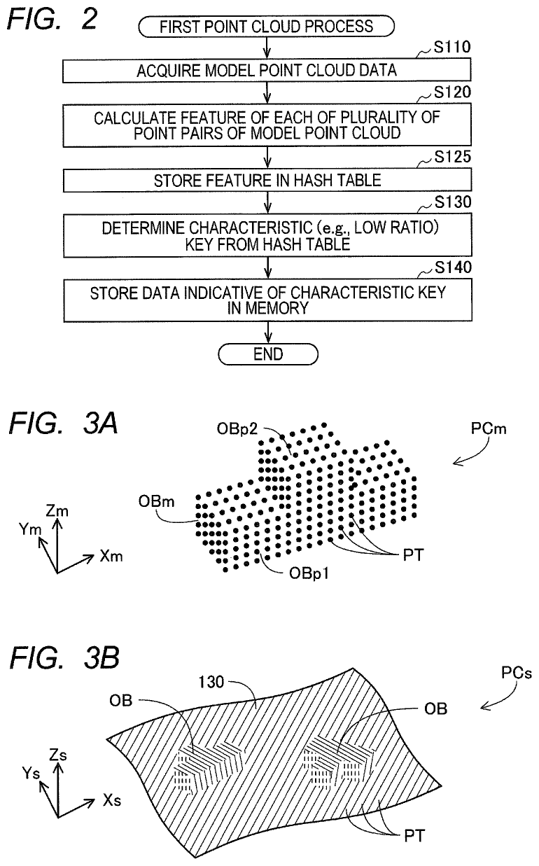

FIG. 2 is a flowchart showing an example of a first point cloud process.

FIG. 3A is a perspective view showing an example of a model point cloud PCm.

FIG. 3B is a perspective view showing an example of a scene point cloud PCs.

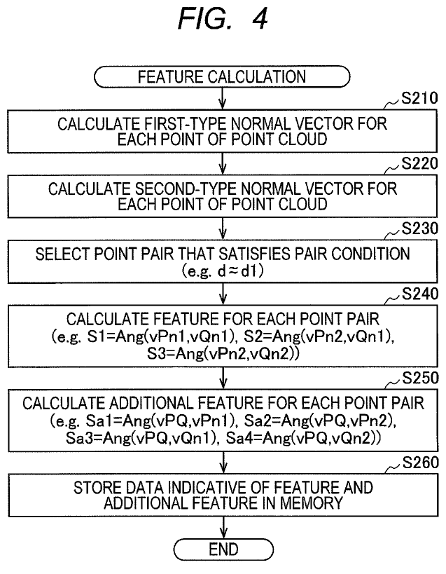

FIG. 4 is a flowchart showing an example of a feature calculation process.

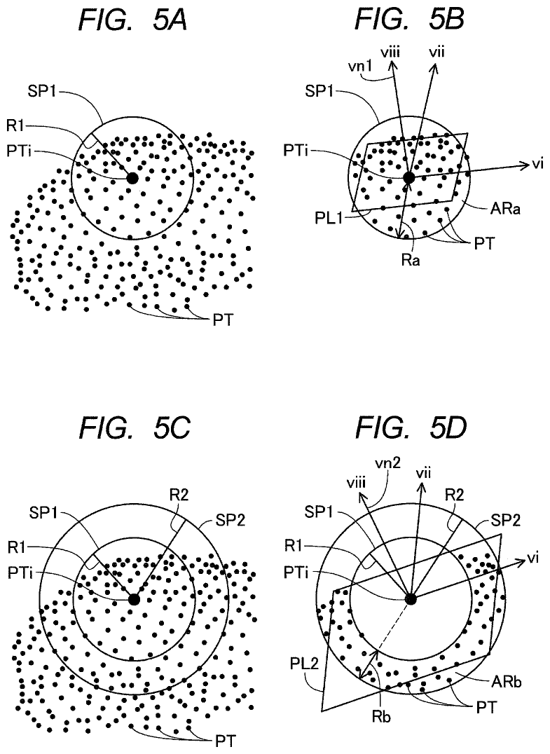

FIGS. 5A and 5B are schematic diagrams showing examples of first-type normal vectors.

FIGS. 5C and 5D are schematic diagrams showing examples of second-type normal vectors.

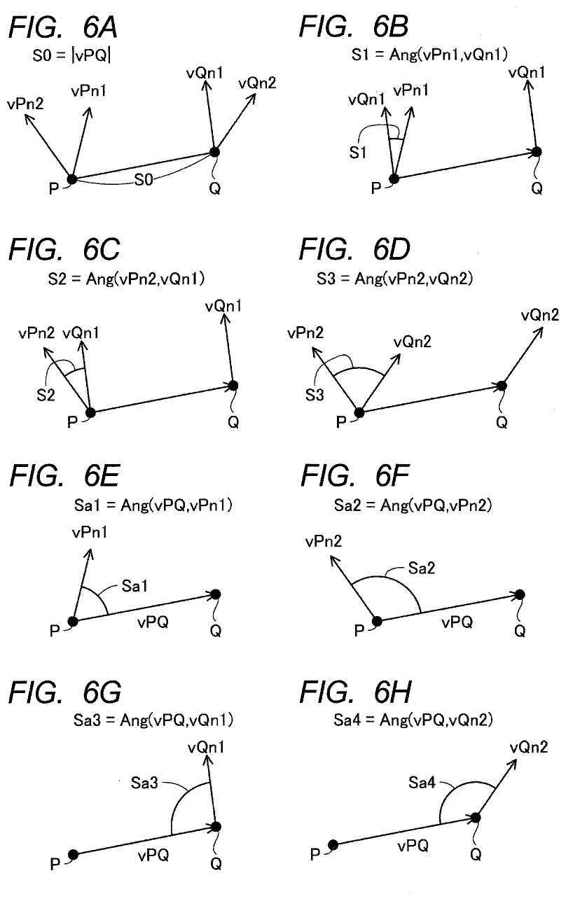

FIGS. 6A, 6B, 6C and 6D are schematic diagrams of parameters S0, S1, S2 and S3, respectively.

FIGS. 6E, 6F, 6G and 6H are schematic diagrams of additional parameters Sa1, Sa2, Sa3 and Sa4, respectively.

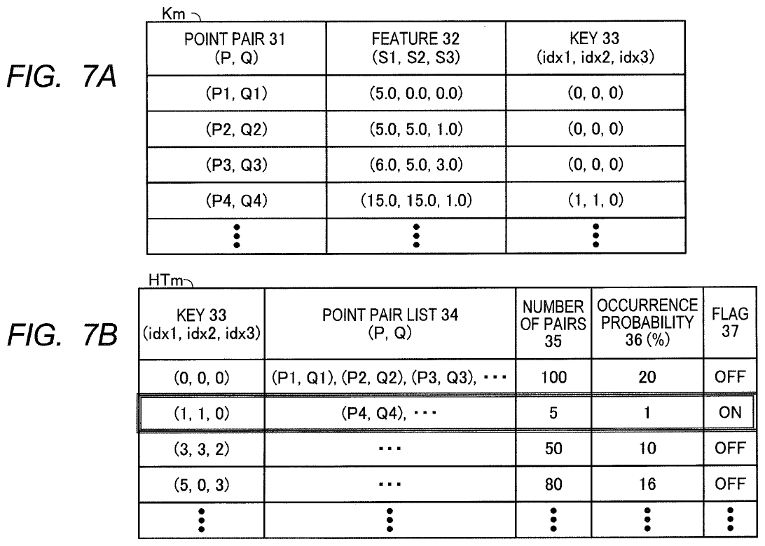

FIG. 7A is a schematic diagram showing an example of a model key table Km.

FIG. 7B is a schematic diagram showing an example of a model hash table HTm.

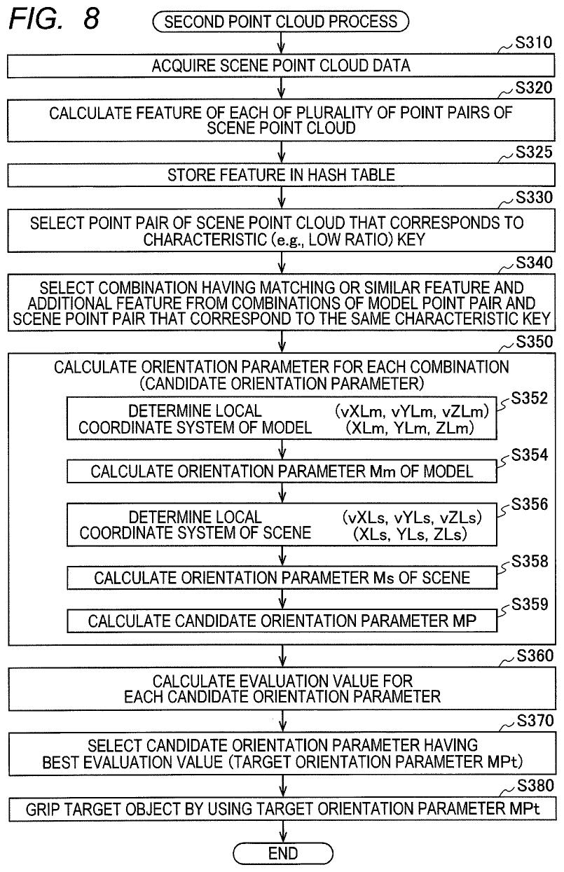

FIG. 8 is a flowchart showing an example of a second point cloud process.

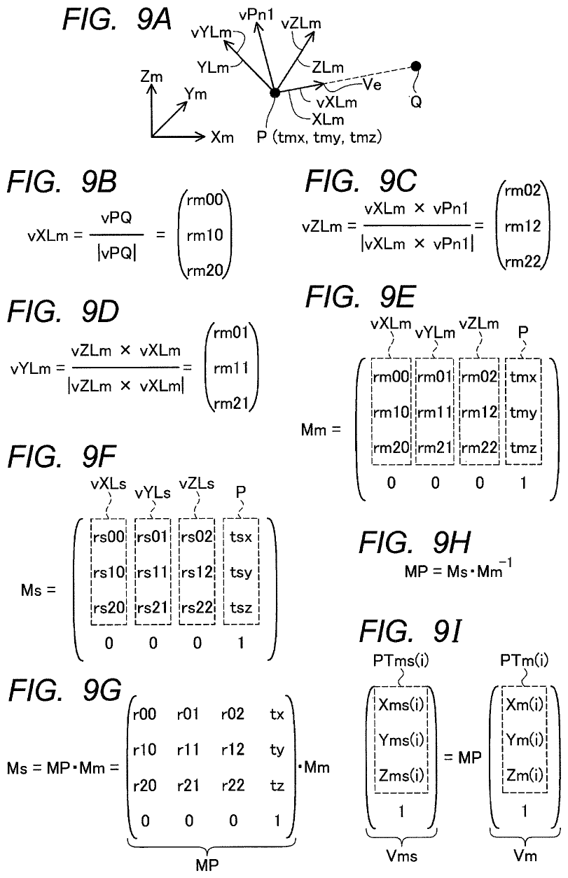

FIGS. 9A, 9B, 9C and 9D are schematic diagrams of a local coordinate system.

FIG. 9E shows a formula for calculating a model orientation parameter Mm.

FIG. 9F shows a formula for calculating a scene orientation parameter Ms.

FIG. 9G shows a relational expression of orientation parameters Ms, MP, and Mm.

FIG. 9H shows a formula for calculating a candidate orientation parameter MP.

FIG. 9I shows a correspondence relationship between an i-th point PTm(i) of the model point cloud PCm and a projection point PTms(i).

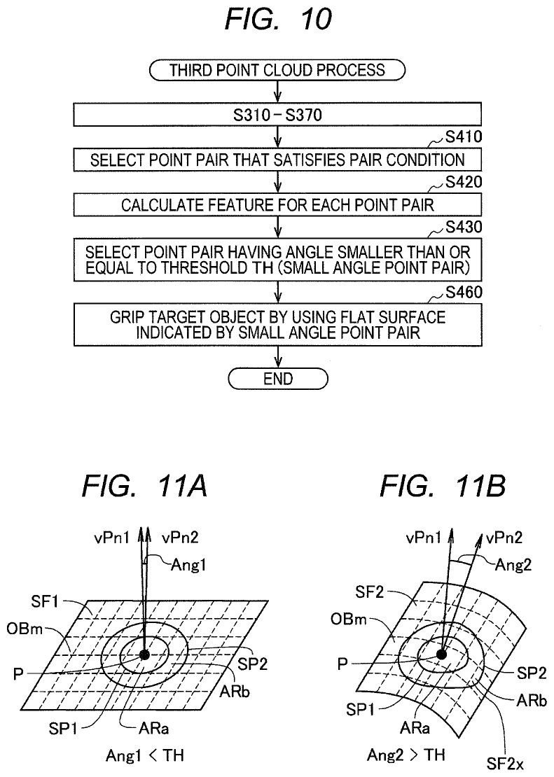

FIG. 10 is a flowchart showing a point cloud process.

FIGS. 11A and 11B are explanatory diagrams showing a relationship between an angle and a shape of a surface of a three-dimensional object.

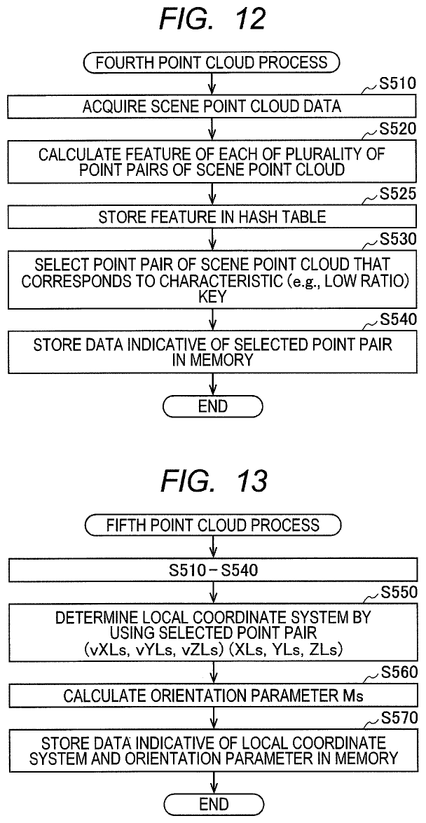

FIG. 12 is a flowchart showing a point cloud process.

FIG. 13 is a flowchart showing a point cloud process.

### A. FIRST EMBODIMENT

### A1. Apparatus Configuration

FIG. 1 is a schematic diagram showing a data processing apparatus as an embodiment. A data processing apparatus 200 is, for example, a personal computer. A three-dimensional sensor 110 and a robot arm 120 are connected to the data processing apparatus 200. A tray 130 is arranged in front of the robot arm 120. A plurality of three-dimensional objects OB to be processed are bulk-stacked on the tray 130. That is, the plurality of three-dimensional objects OB are randomly stacked on the tray 130. Hereinafter, the three-dimensional object OB is also simply referred to as a target object OB. As will be described later, the data processing apparatus 200 uses information from the three-dimensional sensor 110 to control the robot arm 120 and cause the robot arm 120 to grip the target object OB. Although illustration is omitted, the data processing apparatus 200 causes the robot arm 120 to move the target object OB from the tray 130 to another location (for example, a belt conveyor in a production line).

The three-dimensional sensor 110 is a sensor that measures the three-dimensional coordinates of each of a plurality of points on the surface of an object. The type of three-dimensional sensor 110 may be of various types, for example stereoscopic, structured light pattern, or time of flight. Stereoscopy, also called passive stereo, is a method of measuring three-dimensional coordinates on the surface of an object using images captured by a plurality of cameras. Structured light pattern, also called active stereo technique, is a technique that uses a pattern of light projected onto an object to measure three-dimensional coordinates on the surface of the object. Time-of-flight is a method of measuring three-dimensional coordinates on the surface of an object by using the time from when light such as laser or infrared light is transmitted until the light reflected from the object returns. A three-dimensional sensor is also called a depth sensor that measures the distance (also called depth) from the three-dimensional sensor to the surface of an object. In this embodiment, a measurement direction 110x of the three-dimensional sensor 110 is directed toward the tray 130 (the measurement direction 110x indicates a measurable direction). The three-dimensional sensor 110 measures a space (also called a scene) containing a plurality of target objects OB on tray 130.

The configuration of the robot arm 120 may be of various configurations capable of moving an object. In this embodiment, the robot arm 120 has a plurality of links 121, 122, 123, and 124 and a plurality of fingers 126. The plurality of links 121 to 124 forms a link mechanism 125 having an open chain structure. The plurality of fingers 126 are configured to grip an object. The plurality of fingers 126 are attached to the tip of the link mechanism 125. The link mechanism 125 and the plurality of fingers 126 are driven by a plurality of electric motors (not shown). The data processing apparatus 200 controls the plurality of electric motors to move the robot arm 120.

The data processing apparatus 200 includes a processor 210 (controller), a memory 215, a display 240, an operation interface 250, and a communication interface 270. These elements are connected to one another via a bus. The memory 215 includes a volatile memory 220 and a non-volatile memory 230.

The processor 210 is a device configured to perform data processing, and is a CPU, for example. The volatile memory 220 is, for example, a DRAM. The non-volatile memory 230 is, for example, a flash memory. The non-volatile memory 230 stores a first program 231 and a second program 232. The non-volatile memory 230 further stores each data of a model point cloud PCm, a model feature Fm, a model key table Km, a model hash table HTm, a scene point cloud PCs, a scene feature Fs, a scene key table Ks, and a scene hash table HTs. Details of these programs and data will be described later.

The display 240 is a device configured to display images, such as a liquid crystal display or an organic EL display. The operation interface 250 is a device such as a button, a lever, a touch panel overlaid on the display 240, and configured to receive an operation by a user. A user inputs various instructions to the data processing apparatus 200 by operating the operation interface 250. The communication interface 270 is an interface for communicating with other devices (for example, a USB interface, a wired LAN interface, an IEEE802.11 wireless interface). The three-dimensional sensor 110 and the robot arm 120 are connected to the communication interface 270.

### A2. First Point Cloud Process

FIG. 2 is a flow chart showing an example of a first point cloud process. The first point cloud process is processing for searching for distinctive point pairs from the model point cloud PCm. The processor 210 of the data processing apparatus 200 executes the first point cloud process according to the first program 231.

In S110 (FIG. 2), the processor 210 acquires data of the model point cloud PCm from the non-volatile memory 230. FIG. 3A is a perspective view showing an example of the model point cloud PCm. The model point cloud PCm has a plurality of points PT indicating the surface of a reference object OBm, which is the reference of the three-dimensional object OB. The model point cloud PCm indicates the coordinates of each of the plurality of points PT. The coordinates of the point PT are represented by a coordinate system defined by three coordinate axes Xm, Ym, and Zm perpendicular to one another (hereinafter, this coordinate system will be referred to as a model coordinate system). In the example of FIG. 3A, the reference object OBm has a stick-shaped first portion OBp1 and a protruding portion OBp2 that protrudes from the middle of the first portion OBp1. In the drawing, illustration of a plurality of points PT on the portion hidden behind of the outer surface of the reference object OBm is omitted. Note that the shape of the reference object OBm (that is, the shape of the target object OB) may be any other shape. For example, the target objects OB may be parts of various shapes, such as electrical parts (switches, terminals, and so on) or mechanical parts (screws, nuts, pipes, and so on).

In this embodiment, the model point cloud PCm is generated preliminarily by using CAD data representing the three-dimensional shape of the reference object OBm (“CAD” is abbreviation of computer-aided design). The CAD data indicates a design drawing of the target object OB. A plurality of points PT are arranged on the outer surface of the reference object OBm indicated by the CAD data. Then, the coordinates of each point PT are calculated according to the CAD data. The model point cloud PCm indicates the coordinates of each calculated point PT. The model point cloud PCm may be generated by measuring the actual target object OB with the three-dimensional sensor 110.

In S120 (FIG. 2), the processor 210 calculates a feature for each of the plurality of point pairs of the model point cloud PCm. FIG. 4 is a flowchart showing an example of a feature calculation process. In S210, the processor 210 calculates a first-type normal vector for each point PT of the model point cloud PCm. FIGS. 5A and 5B are schematic diagrams showing examples of first-type normal vectors. Each figure shows a point of interest PTi selected from a plurality of points PT and a first sphere SP1 having a first radius R1 centered at the point of interest PTi. A range Ra indicates a range whose distance from the point of interest PTi is greater than or equal to zero and smaller than or equal to the first radius R1 (hereinafter, the range Ra is also referred to as a small range Ra). A small area ARa is an area whose distance from the point of interest PTi is within the small range Ra, and is an area within the first sphere SP1.

FIG. 5B shows a first-type normal vector vn1 with respect to the point of interest PTi. In this embodiment, the first-type normal vector vn1 is the normal vector of a first approximate plane PL1 that approximates the points PT included in the small area ARa. Hereinafter, it is assumed that the length of the first-type normal vector vn1 is 1 (that is, a unit length).

Various methods may be used to determine the first approximate plane PL1, that is, to calculate the first-type normal vector vn1. The calculation method of this embodiment is as follows. The processor 210 calculates three eigenvectors vi, vii, and viii of the variance-covariance matrix by performing so-called principal component analysis on a plurality of points PT within the small area ARa (FIG. 5B). The three eigenvectors vi, vii, and viii are perpendicular to one another. The descending order of variance is the order of eigenvectors vi, vii, and viii (the eigenvector vi has the largest variance). The first approximate plane PL1 is parallel to both the first eigenvector vi (that is, first principal component) and the second eigenvector vii (that is, second principal component). The third eigenvector viii is perpendicular to the other eigenvectors vi and vii. That is, the third eigenvector viii is perpendicular to the first approximate plane PL1. The processor 210 adopts the third eigenvector viii as the first-type normal vector vn1. Although illustration is omitted, the first approximate plane PL1 includes the center of gravity of the plurality of points PT included in the small area ARa. The first approximate plane PL1 may include the point of interest PTi or may be arranged at a position away from the point of interest PTi.

In S220 (FIG. 4), the processor 210 calculates a second-type normal vector for each point PT of the model point cloud PCm. FIGS. 5C and 5D are schematic diagrams showing examples of the second-type normal vectors. Each figure shows the point of interest PTi, the first sphere SP1, and a second sphere SP2 having a second radius R2 centered on the point of interest PTi. A range Rb indicates a range whose distance from the point of interest PTi is greater than the first radius R1 and smaller than or equal to the second radius R2 (hereinafter, the range Rb is also referred to as a large range Rb). A large area ARb is an area whose distance from the point of interest PTi is within the large range Rb, and is the area remaining after excluding the small area ARa from the area inside the second sphere SP2. FIG. 5D shows a second-type normal vector vn2 with respect to the point of interest PTi. In this embodiment, the second-type normal vector vn2 is the normal vector of a second approximate plane PL2 that approximates a plurality of points PT included in the large area ARb. Hereinafter, it is assumed that the length of the second-type normal vector vn2 is 1 (that is, a unit length).

The method for calculating the second-type normal vector vn2 is the same as the method for calculating the first-type normal vector vn1, except that the plurality of points PT included in the large area ARb are used instead of the small area ARa. The processor 210 calculates three eigenvectors vi, vii, and viii of the variance-covariance matrix by performing principal component analysis on a plurality of points PT within the large area ARb (FIG. 5D). The descending order of variance is the order of eigenvectors vi, vii, and viii (the eigenvector vi has the largest variance). The second approximate plane PL2 is parallel to both the first eigenvector vi and the second eigenvector vii. The third eigenvector viii is perpendicular to the second approximate plane PL2. The processor 210 adopts the third eigenvector viii as the second-type normal vector vn2. Although not shown, the second approximate plane PL2 includes the center of gravity of the plurality of points PT included in the large area ARb. The second approximate plane PL2 may include the point of interest PTi or may be arranged at a position away from the point of interest PTi.

As shown in FIGS. 5B and 5D, the large area ARb includes an area that is not included in the small area ARa. Thus, the second-type normal vector vn2 may be different from the first-type normal vector vn1. In a case where a plurality of points PT in the small area ARa and a plurality of points PT in the large area ARb are located on the same plane, the difference (for example, the angle) between the first-type normal vector vn1 and the second-type normal vector vn2 is small. The point of interest PTi may be located at a portion having a complicated shape (for example, a curved portion, a corner portion, and so on) among the surface of the reference object OBm. In this case, the difference between the first approximate plane PL1 and the second approximate plane PL2 can become large. That is, the difference between the first-type normal vector vn1 and the second-type normal vector vn2 can become large.

In S230 (FIG. 4), the processor 210 selects point pairs that satisfy a pair condition from the model point cloud PCm (hereinafter, point pairs selected from the model point cloud PCm are also referred to as model point pairs). In this embodiment, the pair condition is that a distance d between the two points PT is within a particular distance range including a reference distance d1. The reference distance d1 is preliminarily determined. The reference distance d1 may be determined, for example, to a value that is approximately the same as or smaller than the size of a portion having a complicated shape among the surface of the reference object OBm. In this embodiment, the reference distance d1 is larger than the first radius R1 (FIG. 5B). The particular distance range is preliminarily determined such that any distance within the particular distance range is approximately the same as the reference distance d1. The particular distance range is, for example, a range determined using an allowable width dW, and may be a range greater than or equal to d1−dW and smaller than or equal to d1+dW. The allowable width dW may be determined depending on the resolution of the point cloud. The resolution of the point cloud indicates the density of a plurality of points included in the point cloud, and the smaller the sampling interval of the plurality of points, the higher the resolution. The allowable width dW may be, for example, approximately twice the sampling interval of the model point cloud PCm. Normally, a plurality of model point pairs are selected from the model point cloud PCm. As will be described later, the process of FIG. 4 is also used to calculate features of point pairs of a scene point cloud PCs. The resolution may be different between the model point cloud PCm and the scene point cloud PCs. In this case, the allowable width dW may be common to the model point cloud PCm and the scene point cloud PCs. The common allowable width dW may be determined, for example, according to a lower resolution (that is a larger sampling interval). Alternatively, the allowable width dW for the model point cloud PCm may be determined using the sampling interval of the model point cloud PCm, and the allowable width dW for the scene point cloud PCs may be determined using the sampling interval of the scene point cloud PCs.

As will be described later, the point pairs are used to determine the orientation (pose) of the target object OB. Thus, in a case where a combination of two points forming the point pair is the same between two point pairs but the arrangement of a first point P and a second point Q is reversed between the two point pairs, the processor 210 treats the two point pairs as different point pairs.

In S240, the processor 210 calculates a feature for each of the plurality of point pairs selected in S230. The feature includes parameters that indicate the feature of a point pair. FIGS. 6A, 6B, 6C and 6D are schematic diagrams of four parameters S0, S1, S2, and S3 that indicate the feature of the point pair. Each figure indicates the first point P and the second point Q forming one point pair. The first point P is associated with two vectors vPn1 and vPn2. The vector vPn1 is the first-type normal vector of the first point P, and the vector vPn2 is the second-type normal vector of the first point P. The second point Q is associated with two vectors vQn1 and vQn2. The vector vQn1 is the first-type normal vector of the second point Q, and the vector vQn2 is the second-type normal vector of the second point Q.

FIG. 6A shows a zero parameter S0. The zero parameter S0 is the distance between the first point P and the second point Q. As described in S230 (FIG. 4), the zero parameter S0 of each of the plurality of point pairs is approximately the same as the reference distance d1. Since the zero parameter S0 is approximately the same among the plurality of point pairs, the zero parameter S0 is not used as the feature.

In this embodiment, the feature include three parameters S1, S2 and S3 described below. FIG. 6B shows the first parameter S1. The first parameter S1 is the angle between the first-type normal vector vPn1 of the first point P and the first-type normal vector vQn1 of the second point Q (the angle S1 is larger than or equal to 0 degrees and smaller than or equal to 180 degrees). A function Ang in the figure is a function for calculating an angle formed by two argument vectors.

FIG. 6C shows the second parameter S2. The second parameter S2 is the angle between the second-type normal vector vPn2 of the first point P and the first-type normal vector vQn1 of the second point Q (the angle S2 is larger than or equal to 0 degrees and smaller than or equal to 180 degrees).

FIG. 6D shows the third parameter S3. The third parameter S3 is the angle between the second-type normal vector vPn2 of the first point P and the second-type normal vector vQn2 of the second point Q (the angle S3 is larger than or equal to 0 degrees and smaller than or equal to 180 degrees).

As described with reference to FIGS. 5A to 5D, in a case where a portion including the point of interest PTi among the surface of the reference object OBm forms a flat plane, the angle formed by the first-type normal vector vn1 and the second-type normal vector vn2 can be small. In a case where the three-dimensional shape of the portion including the point of interest PTi is complicated, the angle formed by the first-type normal vector vn1 and the second-type normal vector vn2 can be large. Similarly, in a case where a portion including the points P and Q forming the point pair among the surface of the reference object OBm forms a flat plane, each of the parameters S1, S2, and S3 can be small. In a case where the three-dimensional shape of the portion including the points P and Q is complicated, each of the parameters S1, S2 and S3 can be large. In this way, the parameters S1, S2 and S3 indicate geometric features of the reference object OBm.

In S250 (FIG. 4), the processor 210 calculates an additional feature for each of the plurality of point pairs selected in S230. The additional feature includes four parameters Sa1, Sa2, Sa3, and Sa4 that indicate the features of a point pair (the parameters Sa1, Sa2, Sa3, and Sa4 are hereinafter referred to as additional parameters Sa1, Sa2, Sa3, and Sa4).

FIGS. 6E, 6F, 6G and 6H are schematic diagrams of the additional parameters Sa1, Sa2, Sa3, and Sa4. A vector vPQ in each figure is a vector defined by a start point which is the first point P and an end point which is the second point Q (referred to as a base vector vPQ).

FIG. 6E is a schematic diagram of the first additional parameter Sa1. The first additional parameter Sa1 is the angle between the base vector vPQ and the first-type normal vector vPn1 of the first point P (the angle Sa1 is larger than or equal to 0 degrees and smaller than or equal to 180 degrees).

FIG. 6F is a schematic diagram of the second additional parameter Sa2. The second additional parameter Sa2 is the angle between the base vector vPQ and the second-type normal vector vPn2 of the first point P (the angle Sa2 is larger than or equal to 0 degrees and smaller than or equal to 180 degrees).

FIG. 6G is a schematic diagram of the third additional parameter Sa3. The third additional parameter Sa3 is the angle between the base vector vPQ and the first-type normal vector vQn1 of the second point Q (the angle Sa3 is larger than or equal to 0 degrees and smaller than or equal to 180 degrees).

FIG. 6H is a schematic diagram of the fourth additional parameter Sa4. The fourth additional parameter Sa4 is the angle between the base vector vPQ and the second-type normal vector vQn2 of the second point Q (the angle Sa4 is larger than or equal to 0 degrees and smaller than or equal to 180 degrees).

Both points P and Q indicate the surface of the reference object OBm. The normal vectors vPn1 and vPn2 change according to the three-dimensional shape of a portion including the first point P among the surface of the reference object OBm. Similarly, the normal vectors vQn1 and vQn2 change according to the three-dimensional shape of a portion including the second point Q among the surface of the reference object OBm. Thus, the additional parameters Sa1 to Sa4 change according to the three-dimensional shape of a portion including the points P and Q among the reference object OBm. The additional parameters Sa1 to Sa4 thus indicate the geometric features of the reference object OBm.

In S260, the processor 210 stores, in the memory 215 (here, the non-volatile memory 230), data of a model feature Fm including the features S1 to S3 and the additional features Sa1 to Sa4 of each point pair. Then, the process of FIG. 4, that is, the process of S120 of FIG. 2 ends.

In S125, the processor 210 stores the feature of each of the plurality of point pairs calculated in S120 in a hash table. In this embodiment, the processor 210 first generates a model key table Km. FIG. 7A is a schematic diagram showing an example of the model key table Km. The model key table Km shows a correspondence relationship among a point pair 31, a feature 32, and a key 33. The point pair 31 indicates a combination of the first point P and the second point Q of the point pair selected in S230 (FIG. 4). The feature 32 indicates a combination of the three parameters S1, S2, and S3. The key 33 indicates three indices idx1, idx2, and idx3 acquired by quantizing the three parameters S1, S2, and S3.

In this embodiment, each of the parameters S1, S2, and S3 indicates an angle within a range that is larger than or equal to 0 degrees and smaller than or equal to 180 degrees. This range of 180 degrees is divided into a plurality of sections (for example, 18 sections each having a width of 10 degrees). Each section is assigned a number starting from 0 in ascending order of angle. For example, an index of 0 indicates a section larger than or equal to 0 degrees and smaller than 10 degrees, and an index of 1 indicates a section larger than or equal to 10 degrees and smaller than 20 degrees. The first index idx1 indicates the section number to which the first parameter S1 belongs. The second index idx2 indicates the number of the section to which the second parameter S2 belongs. The third index idx3 indicates the number of the section to which the third parameter S3 belongs. In this way, the three indices idx1, idx2, and idx3 indicated by the key 33 indicate the three quantized parameters S1, S2, and S3. The processor 210 stores the generated data of the model key table Km in the memory 215 (here, the non-volatile memory 230).

The processor 210 creates a model hash table HTm by using the model key table Km. FIG. 7B is a schematic diagram showing an example of the model hash table HTm. The model hash table HTm shows a correspondence relationship among the key 33, a point pair list 34, a number of pairs 35, an occurrence probability 36, and a flag 37. The key 33 is the same as the key 33 in FIG. 7A. The point pair list 34 is a list of point pairs associated with the key 33. The number of pairs 35 is the number of point pairs associated with the key 33. The occurrence probability 36 is the ratio of the number of pairs 35 to the total number of point pairs. The flag 37 indicates whether the key 33 is characteristic (details will be described later).

The processor 210 initializes the model hash table HTm. By initialization, the point pair list 34 is set to empty, the number of pairs 35 and the occurrence probability 36 are set to zero, and the flag 37 is set to off. The processor 210 selects a point pair from the model key table Km (FIG. 7A) and updates the model hash table HTm according to the selected point pair (referred to as a point pair of interest). Specifically, the processor 210 adds the point pair of interest to the point pair list 34 corresponding to the key 33 of interest that is the key 33 of the point pair of interest. The processor 210 adds 1 to the number of pairs 35 corresponding to the key 33 of interest. The processor 210 executes the above process for all point pairs in the model key table Km. The processor 210 then calculates the occurrence probability 36 of each key 33. Here, it is assumed that the total number of point pairs is 500.

In S130 (FIG. 2), the processor 210 determines a characteristic key 33 from the plurality of keys 33 of the model hash table HTm (FIG. 7B). In this embodiment, the key 33 having the occurrence probability 36 that satisfies a low ratio condition is selected as the characteristic key 33. The low ratio condition is a condition including that the occurrence probability 36 is lower than or equal to an upper limit. In this embodiment, the upper limit is preliminarily determined (for example, 3%). The low occurrence probability 36 indicates a high uniqueness of the key 33 (that is, the feature 32). The high uniqueness of the feature 32 indicates a high uniqueness of the shape of the portion indicated by the point pair corresponding to the feature 32 (here, a portion of the reference object OBm). Such discriminative point pair is suitable for matching point pairs between the model point cloud PCm and the scene point cloud PCs, which will be described later.

The occurrence probability 36 may contain noise due to various causes. For example, the coordinates of points may contain noise (for example, measurement error of the three-dimensional sensor 110, and so on). Due to noise contained in the coordinates of points, inappropriate feature 32 (and thus key 33) that should not be calculated from the reference object OBm may be calculated. Such inappropriate key 33 is usually rare. In order to avoid an inappropriate key 33 being selected as the distinctive key 33, in this embodiment, the low ratio condition includes that the occurrence probability 36 is higher than or equal to a lower limit. In this embodiment, the lower limit is preliminarily determined to be greater than zero and smaller than the upper limit (for example, 0.1%).

The processor 210 refers to the occurrence probability 36 of each key 33 in the model hash table HTm (FIG. 7B), and turns on the flag 37 corresponding to the occurrence probability 36 that satisfies the low ratio condition. In the example of FIG. 7B, the occurrence probability 36 of the key 33 of (1, 1, 0) satisfies the low ratio condition, so the flag 37 of this key 33 is set to ON. The point pair corresponding to the flag 37 that is ON is characteristic, that is, distinctive.

In S140 (FIG. 2), the processor 210 stores data indicating the characteristic key 33 in the memory 215 (here, the non-volatile memory 230). In this embodiment, the processor 210 stores data representing the model hash table HTm (FIG. 7B) in the non-volatile memory 230. Then, the process of FIG. 2 ends.

### A3. Second Point Cloud Process

FIG. 8 is a flow chart showing an example of a second point cloud process. The second point cloud process includes a process of calculating orientation parameters for matching between the coordinates of the reference object OBm represented by the model point cloud PCm and the coordinates of the target object OB represented by the scene point cloud PCs measured by the three-dimensional sensor 110 (FIG. 1). The processor 210 of the data processing apparatus 200 executes the second point cloud process according to the second program 232. The processor 210 acquires the position and orientation of the target object OB represented by the scene point cloud PCs by using the orientation parameters. In this embodiment, the processor 210 causes the robot arm 120 to grip the target object OB based on the acquired position and orientation.

In S310, the processor 210 acquires data of the scene point cloud PCs. In this embodiment, the processor 210 acquires the data of the scene point cloud PCs from the three-dimensional sensor 110 (FIG. 1) by causing the three-dimensional sensor 110 (FIG. 1) to measure a space containing a plurality of target objects OB. FIG. 3B is a perspective view showing an example of the scene point cloud PCs. The scene point cloud PCs indicates the coordinate of each of a plurality of points PT on the surface that are visible from the three-dimensional sensor 110, among the surface of the object within the measurement range of the three-dimensional sensor 110. FIG. 3B shows a part of the scene point cloud PCs. A portion of the tray 130 and two target objects OB on the tray 130 are shown in the figure. In the figure, illustration of individual points PT is omitted, and the surfaces represented by the plurality of points PT are indicated by hatching. Although illustration is omitted, a plurality of target objects OB may be stacked on the tray 130. In this case, the scene point cloud PCs indicates the plurality of points PT on the surface visible from the three-dimensional sensor 110 among the plurality of stacked target objects OB.

The scene point cloud PCs indicates the coordinates of each of the plurality of points PT. The coordinates of the point PT are represented by a coordinate system defined by three coordinate axes Xs, Ys, and Zs perpendicular to one another (hereinafter, this coordinate system will be referred to as a scene coordinate system). The scene coordinate system is a coordinate system that represents a position relative to the three-dimensional sensor 110. For example, the origin of the scene coordinate system may be located at the position of the three-dimensional sensor 110. Also, one coordinate axis (for example, the third coordinate axis Zs) may be parallel to the measurement direction 110x of the three-dimensional sensor 110. As will be described below, the processor 210 determines a positional relationship between the target object OB represented by the scene point cloud PCs and the reference object OBm represented by the model point cloud PCm, by using a point pair that indicates a characteristic portion of the target object OB (that is, discriminative point pair).

The processes of S320 and S325 (FIG. 8) are the same as the processes of S120 and S125 of FIG. 2, respectively, except that the scene point cloud PCs is used instead of the model point cloud PCm. In S320, the processor 210 executes the process of FIG. 4. The processor 210 calculates a feature for each of a plurality of point pairs of the scene point cloud PCs (the point pairs selected from the scene point cloud PCs are hereinafter also referred to as scene point pairs). The processor 210 stores the data of the scene feature Fs including the feature and the additional feature of each scene point pair in the memory 215 (here, the non-volatile memory 230). In S325, the processor 210 generates a scene key table Ks and a scene hash table HTs. The structure of the information Fs, Ks, and HTs is the same as the structure of the information Fm, Km, and HTm, respectively, except that the information relates to the scene point cloud PCs instead of the model point cloud PCm.

In S330, the processor 210 selects point pairs of the scene point cloud PCs that correspond to the characteristic key 33. The characteristic key 33 is the key 33 determined in S130 (FIG. 2) and the key 33 corresponding to the ON flag 37 (FIG. 7B). The processor 210 selects the point pairs corresponding to the characteristic key 33 by referring to the scene hash table HTs. Hereinafter, the point pair of the scene point cloud PCs corresponding to the characteristic key 33 is also referred to as a characteristic scene point pair. Further, the point pair of the model point cloud PCm corresponding to the characteristic key 33 is also referred to as a characteristic model point pair. It is highly likely that the characteristic model point pair and the characteristic scene point pair associated with the same characteristic key 33 indicate the same part of the objects OBm and OB.

In S340, the processor 210 selects a combination that satisfies a selection condition from combinations of a characteristic model point pair and a characteristic scene point pair that correspond to the same characteristic key 33. In this embodiment, the selection condition is that the characteristic model point pair and the characteristic scene point pair have matching or similar feature and additional feature. The processor 210 calculates a degree of similarity of the feature and the additional feature between the characteristic model point pair and the characteristic scene point pair corresponding to the same characteristic key 33. As described in S240 and S250 of FIG. 4, the feature includes three parameters S1 to S3, and the additional feature includes four additional parameters Sa1 to Sa4. The processor 210 computes a difference for each of the seven parameters (the difference is a difference between the characteristic model point pair and the characteristic scene point pair). The processor 210 adopts the maximum difference among the seven differences as the degree of similarity. The processor 210 determines that the feature and the additional feature match or are similar when the degree of similarity is smaller than or equal to a particular allowable threshold. Hereinafter, the combinations of the characteristic model point pair and the characteristic scene point pair selected in S340 will be referred to as particular combinations. Note that the selection condition of the present embodiment includes that the feature of the characteristic model point pair and the feature of the characteristic scene point pair match or are similar, and that the additional feature of the characteristic model point pair and the additional feature of the characteristic scene point pair match or are similar.

The allowable threshold may be determined experimentally such that the arrangement of the characteristic model point pair for the reference object OBm is approximately the same as the arrangement of the characteristic scene point pair for the target object OB when the degree of similarity is smaller than or equal to the allowable threshold. When the degree of similarity is smaller than or equal to the allowable threshold, the difference between the position of the characteristic model point pair for the reference object OBm and the position of the characteristic scene point pair for the target object OB is small. Further, the difference between the direction from the first point P to the second point Q of the characteristic model point pair for the reference object OBm and the direction from the first point P to the second point Q of the characteristic scene point pair for the target object OB is small.

In S350, the processor 210 calculates a candidate orientation parameter for each particular combination. In this embodiment, S350 includes S352 to S359. In S352, the processor 210 determines a local coordinate system for the first point P of the characteristic model point pair of the particular combination. FIGS. 9A to 9D are schematic diagrams of the local coordinate system. FIG. 9A shows the first point P and the second point Q of the characteristic model point pair. Coordinates tmx, tmy, and tmz of the first point P are components of the coordinate axes Xm, Ym, and Zm in the model coordinate system.

The local coordinate system is defined by three coordinate axes XLm, YLm, and ZLm represented by three unit vectors vXLm, vYLm, and vZLm perpendicular to one another. The first axis XLm passes through the first point P and is parallel to the first vector vXLm. The second axis YLm passes through the first point P and is parallel to the second vector vYLm. The third axis ZLm passes through the first point P and is parallel to the third vector vZLm.

FIG. 9B shows a calculation formula for the first vector vXLm. The first vector vXLm is a unit vector parallel to vector vPQ. Components rm00, rm10, and rm20 of the first vector vXLm are components of the coordinate axes Xm, Ym, and Zm, respectively, in the model coordinate system.

FIG. 9C shows a calculation formula for the third vector vZLm. The third vector vZLm is acquired by normalizing the cross product (vector product) of the first vector vXLm and the first-type normal vector vPn1 (that is, the length of the third vector vZLm is 1). Components rm02, rm12, and rm22 of the third vector vZLm are components of the coordinate axes Xm, Ym, and Zm, respectively, in the model coordinate system.

FIG. 9D shows a calculation formula for the second vector vYLm. The second vector vYLm is acquired by normalizing the cross product of the third vector vZLm and the first vector vXLm (that is, the length of the second vector vYLm is 1). Components rm01, rm11, and rm21 of the second vector vYLm are components of the coordinate axes Xm, Ym, and Zm, respectively, in the model coordinate system.

The processor 210 calculates three vectors vXLm, vYLm, and vZLm according to the calculation formulas of FIGS. 9B to 9D. The vectors vXLm, vYLm, and vZLm define the local coordinate system of the characteristic model point pair.

In S354 (FIG. 8), the processor 210 calculates an orientation parameter Mm of the characteristic model point pair (hereinafter the orientation parameter Mm is referred to as a model orientation parameter Mm). FIG. 9E shows a calculation formula for the model orientation parameter Mm. The model orientation parameter Mm is a homogeneous transformation matrix that defines the relationship between the model coordinate system (Xm, Ym, Zm) and the local coordinate system (XLm, YLm, ZLm) of the characteristic model point pair. A homogeneous transformation matrix is a matrix of 4 rows and 4 columns representing rotation and translation. The first to third columns indicate the rotation. The fourth column indicates the translation. The four components of the first column consist of the three components (rm00, rm10, rm20) of the first vector vXLm and zero. The four components of the second column consist of the three components (rm01, rm11, rm21) of the second vector vYLm and zero. The four components of the third column consist of the three components (rm02, rm12, rm22) of the third vector vZLm and zero. The four components of the fourth column consist of the coordinates (tmx, tmy, tmz) of the origin of the local coordinate system (here, the first point P) in the model coordinate system and 1. The model orientation parameter Mm transforms the local coordinate system of the characteristic model point pair to the model coordinate system.

In S356 (FIG. 8), the processor 210 determines a local coordinate system for the first point P of the characteristic scene point pair of the particular combination. The determination method of the local coordinate system is the same as the determination method of the local coordinate system for characteristic model point pair in S352, except that characteristic scene point pair is used instead of the characteristic model point pair. The processor 210 calculates three vectors vXLs, vYLs, and vZLs that define the local coordinate system by using the first point P and the second point Q of the characteristic scene point pair. The local coordinate system is defined by three coordinate axes XLs, YLs, and ZLs defined by three vectors vXLs, vYLs, vZLs and the first point P. The first coordinate axis XLs passes through the first point P and is parallel to the first vector vXLs. The second coordinate axis YLs passes through the first point P and is parallel to the second vector vYLs. The third coordinate axis ZLs passes through the first point P and is parallel to the third vector vZLs.

In S358, the processor 210 calculates an orientation parameter Ms of the characteristic scene point pair (hereinafter the orientation parameter Ms is referred to as a scene orientation parameter Ms). The method for calculating the scene orientation parameter Ms is the same as the method for calculating the model orientation parameter Mm in S354, except that the characteristic scene point pair is used instead of the characteristic model point pair. FIG. 9F shows a calculation formula for calculating the scene orientation parameter Ms. The scene orientation parameter Ms is a homogeneous transformation matrix that defines the relationship between the scene coordinate system (Xs, Ys, Zs) and the local coordinate system of the characteristic scene point pair.

The four components of the first column consist of the three components (rs00, rs10, rs20) of the first vector vXLs and zero. The four components of the second column consist of the three components (rs01, rs11, rs21) of the second vector vYLs and zero. The four components of the third column consist of the three components (rs02, rs12, rs22) of the third vector vZLs and zero. The four components of the fourth column consist of the coordinates (tsx, tsy, tsz) of the origin of the local coordinate system (here, the first point P) in the scene coordinate system and 1. The scene orientation parameter Ms transforms the local coordinate system of the characteristic scene point pair to the scene coordinate system.

In S359 (FIG. 8), the processor 210 calculates a candidate orientation parameter MP. FIG. 9G shows a relational expression of the orientation parameters Ms, MP, and Mm. The scene orientation parameter Ms is represented by the product of the candidate orientation parameter MP and the model orientation parameter Mm. In the figure, the components of 4 rows and 4 columns of the candidate orientation parameter MP are shown. The candidate orientation parameter MP is a homogeneous transformation matrix of 4 rows and 4 columns representing translation and rotation, like the orientation parameters Ms and Mm. FIG. 9H shows a calculation formula for the candidate orientation parameter MP which is derived from the relational expression of FIG. 9G. The candidate orientation parameter MP is the product of the scene orientation parameter Ms and the inverse matrix of the model orientation parameter Mm. The processor 210 calculates components r00, r10, r20, r01, r11, r21, r02, r12, r22, tx, ty, and tz of the candidate orientation parameter MP according to the calculation formula of FIG. 9H. The inverse matrix of the homogeneous transformation matrix Mm is calculated by a known method.

The candidate orientation parameter MP projects the model coordinate system onto the scene coordinate system such that the local coordinate system of the characteristic model point pair is projected onto the local coordinate system of the characteristic scene point pair. FIG. 9I shows the correspondence relationship between an i-th point PTm(i) of the model point cloud PCm and a projection point PTms(i). The projection point PTms(i) is a point acquired by projecting the point PTm(i) expressed in the model coordinate system onto the scene coordinate system by using the candidate orientation parameter MP. The number i is an integer greater than or equal to zero and smaller than or equal to Nm−1 (Nm is the total number of points PT in the model point cloud PCm). Components Xm(i), Ym(i), and Zm(i) of the point PTm(i) are components of coordinate axes Xm, Ym, and Zm in the model coordinate system, respectively. Components Xms(i), Yms(i), and Zms(i) of the projection point PTms(i) are components of coordinate axes Xs, Ys, and Zs in the scene coordinate system, respectively. A first vector Vm indicates the point PTm(i) expressed in a homogeneous coordinate system, and is a four-dimensional column vector having three components of the point PTm(i) and 1. A second vector Vms indicates the projection point PTms(i) expressed in the homogeneous coordinate system, and is a four-dimensional column vector having three components of the projection point PTms(i) and 1. The second vector Vms is calculated by multiplying the candidate orientation parameter MP and the first vector Vm. Here, an object acquired by transforming the reference object OBm represented by the model point cloud PCm with the candidate orientation parameter MP according to this calculation formula is referred to as a transformed reference object. The transformed reference object roughly matches the target object OB represented by the scene point cloud PCs (here, the target object OB corresponding to the characteristic scene point pair of the particular combination).

In this way, in S350 (FIG. 8), the processor 210 calculates the candidate orientation parameter MP for each particular combination.

In S360, the processor 210 calculates an evaluation value for each candidate orientation parameter MP. The evaluation value is an evaluation value of the magnitude of the deviation between the model point cloud PCm projected from the model coordinate system to the scene coordinate system according to the candidate orientation parameter MP (that is, the reference object OBm) and the target object OB represented by the scene point cloud PCs. In this embodiment, the processor 210 calculates the distance between each of the plurality of points PT indicating the projected reference object OBm and the closest point PT among the plurality of points PT of the scene point cloud PCs. When the projected reference object OBm matches the target object OB of the scene point cloud PCs, the distance of each point PT is small. When the deviation between the projected reference object OBm and the target object OB of the scene point cloud PCs is large, the distance of each point PT is large. The processor 210 calculates, as the evaluation value, an average value of the distances of the plurality of points PT indicating the projected reference object OBm. The smaller the evaluation value, the smaller the deviation between the projected reference object OBm and the target object OB of the scene point cloud PCs.

In S370, the processor 210 selects the candidate orientation parameter MP having the best evaluation value. The processor 210 selects the candidate orientation parameter MP having the best evaluation value (the minimum evaluation value in this embodiment) by rearranging the plurality of candidate orientation parameters MP in ascending order of evaluation values. The selected candidate orientation parameter MP is hereinafter referred to as a target orientation parameter MPt.

In S380, the processor 210 causes the robot arm 120 to grip the target object OB by controlling the robot arm 120 using the target orientation parameter MPt. In this embodiment, a part to be gripped of the target object OB represented by the model point cloud PCm (FIG. 3A) is determined preliminarily. The processor 210 projects the part to be gripped represented in the model coordinate system to the scene coordinate system by using the target orientation parameter MPt. The respective positions (here, coordinates in the scene coordinate system) of the plurality of fingers 126 in various operating states of the robot arm 120 (FIG. 1) are determined preliminarily by experiments. The processor 210 controls the robot arm 120 to move the plurality of fingers 126 in the vicinity of the part to be gripped represented in the scene coordinate system. The processor 210 controls the robot arm 120 to cause the plurality of fingers 126 to grip the part to be gripped of the target object OB. The processor 210 then controls the robot arm 120 to move the gripped target object OB to a predetermined position. Then, the process of FIG. 8 ends. The processor 210 repeatedly executes the process of FIG. 8. Thereby, the processor 210 moves the plurality of target objects OB that are bulk-stacked on the tray 130 to the predetermined position one piece at a time.

As described above, the processor 210 executes the following processes. In S120 of FIG. 2, the processor 210 executes the process of FIG. 4. In S230 of FIG. 4, the processor 210 select point pairs of the first point P and the second point Q separated by a distance within a particular distance range, from the model point cloud PCm including the plurality of points PT representing the surface of the three-dimensional object OBm.

In S240, as described with reference to FIGS. 5A to 5D and 6A to 6D, the processor 210 determines four normal vectors vPn1, vPn2, vQn1, and vQn2. Details will be described below. The processor 210 determines the first-type normal vector vPn1 at the first point P by using the plurality of points PT included in the small area ARa whose distance from the first point P is within the small range Ra (FIG. 5B). The processor 210 determines the second-type normal vector vPn2 at the first point P by using the plurality of points PT included in the large area ARb whose distance from the first point P is within the large range Rb (FIG. 5D). Here, the large range Rb includes a distance larger than the upper limit of the small range Ra. The processor 210 determines the first-type normal vector vQn1 at the second point Q by using the plurality of points PT included in the small area ARa whose distance from the second point Q is within the small range Ra. The processor 210 determines the second-type normal vector vQn2 at the second point Q by using the plurality of points PT included in the large area ARb whose distance from the second point Q is within the large range Rb.

In S240, the processor 210 calculates the feature representing the geometric feature by using these normal vectors vPn1, vPn2, vQn1, and vQn2. The processor 210 executes a particular process by using the calculated feature. The particular process includes S125 and S130 of FIG. 2. In S125 and S130, the processor 210 determines characteristic point pairs (that is, distinctive point pairs) by using the feature.

In S320 in FIG. 8, the processor 210 executes the same processes as the above-described processes (the processes for the model point cloud PCm) on the scene point cloud PCs including the plurality of points PT representing the surface of the three-dimensional object OB.

In this way, in this embodiment, an appropriate feature indicating the geometric feature is calculated by using the two normal vectors at the first point P and the two normal vectors at the second point Q. Further, the characteristic point pair is appropriately determined by using the calculated feature.

In S340, the processor 210 forms particular combinations by using point pairs corresponding to the characteristic key 33. Thus, compared with the case where all point pairs are used to form the particular combinations, the total number of particular combinations processed in S350 and S360 is greatly reduced.

The lower limit of the large range Rb (FIG. 5D) is greater than or equal to the upper limit of the small range Ra (FIG. 5B). Compared with the case where the lower limit of the large range Rb is smaller than the upper limit of the small range Ra, the total number of points PT included in the large area ARb may be reduced, which reduces the amount of calculation for the determination of the second-type normal vectors vPn2 and vQn2 corresponding to the large area ARb. Further, since the influence of the plurality of points PT included in the small area ARa for the second-type normal vectors vPn2 and vQn2 is reduced, the second-type normal vectors vPn2 and vQn2 appropriately indicate characteristics of the large area ARb outside the small area ARa.

In this embodiment, the ranges Ra and Rb are applied to both the first point P and the second point Q. That is, both of the following two conditions are satisfied.

(First condition) The distance range (here, the small range Ra) for determining the first-type normal vector vPn1 of the first point P is the same as the distance range (here, the small range Ra) for determining the first-type normal vector vQn1 of the second point Q.

(Second condition) The distance range (here, the large range Rb) for determining the second-type normal vector vPn2 of the first point P is the same as the distance range (here, the large range Rb) for determining the second-type normal vector vQn2 of the second point Q.

In the process of FIG. 4, features of a plurality of combinations of the first point P and the second point Q (that is, a plurality of point pairs) are calculated. Here, the first point P of a point pair may be the second point Q of another point pair. When the first condition is satisfied, the first-type normal vector vPn1 when the point of interest is the first point P is usable as the first-type normal vector vQn1 when the same point of interest is the second point Q. When the second condition is satisfied, the second-type normal vector vPn2 when the point of interest is the first point P is usable as the second-type normal vector vQn2 when the same point of interest is the second point Q. In this way, the amount of calculation for calculating the normal vectors is reduced.

In S310 of FIG. 8, the processor 210 acquires the scene point cloud PCs generated by measuring the space containing the three-dimensional object OB with the three-dimensional sensor 110. In S320, the processor 210 executes the process of FIG. 4. In S230 of FIG. 4 for the scene point cloud PCs, the processor 210 selects a plurality of scene point pairs of the first point P and the second point Q from the scene point cloud PCs. In S110 of FIG. 2, the processor 210 acquires the model point cloud PCm. The model point cloud PCm includes a plurality of points PT representing the surface of the reference object OBm, which is the reference of the three-dimensional object. In S120, the processor 210 executes the process of FIG. 4. In S230 of FIG. 4 for the model point cloud PCm, the processor 210 selects a plurality of model point pairs of the first point P and the second point Q from the model point cloud PCm.

As described in S120 of FIGS. 2 and S320 of FIG. 8, the processor 210 performs the process of FIG. 4 on a plurality of model point pairs and a plurality of scene point pairs. In S210 and S220 for the plurality of scene point pairs, the processor 210 determines four normal vectors vPn1, vPn2, vQn1, and vQn2 for each of the plurality of scene point pairs. In S210 and S220 for the plurality of model point pairs, the processor 210 determines four normal vectors vPn1, vPn2, vQn1, and vQn2 for each of the plurality of model point pairs.

In S240 for the plurality of scene point pairs, the processor 210 calculates a first-type feature, which is the feature for each of the plurality of scene point pairs. In S240 for the plurality of model point pairs, the processor 210 calculates a second-type feature, which is the feature for each of the plurality of model point pairs.

The particular process using the feature includes S340 in FIG. 8. The processor 210 executes the process of S340 by using the first-type feature and the second-type feature. In S340, the processor 210 selects the particular combination that is a combination of the scene point pair and the model point pair that satisfies the selection condition. The selection condition includes that the first-type feature and the second-type feature match or are similar to each other. In this way, the processor 210 selects a suitable particular combination of the scene point pair selected from the scene point cloud PCs and the model point pair selected from the model point cloud PCm. The processor 210 may store data indicating the particular combination in the memory 215 (for example, the non-volatile memory 230).

The particular process using the feature includes S325 in FIGS. 8 and S125 in FIG. 2. In S325 of FIG. 8, the processor 210 stores the plurality of first-type features of the plurality of scene point pairs in the scene hash table HTs. As a result, the plurality of first-type features are classified into a plurality of categories. The key 33 of the hash table (FIG. 7B) is an example of a category (the key 33 is also called category 33). In S125 of FIG. 2, the processor 210 stores the plurality of second-type features of the plurality of model point pairs in the model hash table HTm. As a result, the plurality of second-type features are classified into the plurality of categories 33.

In S125 of FIG. 2, the processor 210 calculates the occurrence probability 36 of each key 33 (category 33) of the model hash table HTm (FIG. 7B). The occurrence probability 36 is the ratio of the number of model point pairs included in the category 33 to the total number of model point pairs. In the selection process for selecting particular combinations (FIG. 8: S340), the processor 210 selects the particular combination from combinations of the model point pair and the scene point pair included in the same characteristic category 33. As described in S130 of FIG. 2, the characteristic category 33 is the category 33 having the occurrence probability 36 that satisfies the low ratio condition. The low ratio condition includes that the occurrence probability 36 is smaller than or equal to the upper limit. In this manner, the processor 210 selects the particular combinations of distinctive point pairs included in the category 33 that satisfies the low ratio condition.

As described in S250 of FIG. 4, the processor 210 calculates the additional feature representing the geometric feature by using the first point P and the second point Q in addition to the four normal vectors vPn1, vPn2, vQn1, and vQn2. As described in S120 of FIGS. 2 and S320 of FIG. 8, the processor 210 performs the process of FIG. 4 on the plurality of model point pairs and the plurality of scene point pairs. In S250 (FIG. 4) for the plurality of scene point pairs, the processor 210 calculates a first-type additional feature which is an additional feature for each of the plurality of scene point pairs. In S250 for the plurality of model point pairs, the processor 210 calculates a second-type additional feature which is an additional feature for each of the plurality of model point pairs. In S340 of FIG. 8, the processor 210 selects the particular combinations of the scene point pair and the model point pair that satisfies the selection condition. The selection condition includes that the first-type additional feature and the second-type additional feature match or are similar to each other. In this way, the additional features are used in addition to the features for selecting the particular combinations. Thus, the processor 210 reduces a possibility that an inappropriate combination of the scene point pair and the model point pair is selected as the particular combination.

The particular process using the feature includes S352 and S356 of FIG. 8. In S352, the processor 210 determines the local coordinate system having the first axis XLm, the second axis YLm, and the third axis ZLm that are perpendicular to one another by using the model point pair that forms the particular combination (FIG. 9A). As described with reference to FIGS. 9A to 9D, the process of determining the local coordinate system includes the process of calculating the three vectors vXLm, vYLm, and vZLm. The first vector vXLm is a vector that defines the first axis XLm. As shown in FIGS. 9A and 9B, the first vector vXLm has a start point, which is the first point P, and an end point Ve, which is located on a straight line passing through the first point P and the second point Q. The third vector vZLm is a vector that defines the third axis ZLm. As shown in FIG. 9C, the third vector vZLm is the cross product of the first-type normal vector vPn1 and the first vector vXLm. The second vector vYLm is a vector that defines the second axis YLm. As shown in FIG. 9D, the second vector vYLm is the cross product of the first vector vXLm and the third vector vZLm. In this way, the processor 210 determines the appropriate local coordinate system by using the model point pair.

Similarly, in S356, the processor 210 determines the local coordinate system having the first axis XLs, the second axis YLs, and the third axis ZLs perpendicular to one another by using the scene point pair that forms the particular combination. The method of determining this local coordinate system is the same as the local coordinate system determination method in S352, except that the scene point pair is used instead of the model point pair.

### B. Second Embodiment

FIG. 10 is a flow chart showing another embodiment of a point cloud process. A third point cloud process is executed by the data processing apparatus 200 (FIG. 1) instead of the second point cloud process of FIG. 8. In this embodiment, as in the embodiment of FIG. 8, the processor 210 causes the robot arm 120 to grip the target object OB. The difference from the embodiment of FIG. 8 is that the processor 210 determines the position to be gripped by analyzing the point cloud. In the present embodiment, the second program 232 is a program for the third point cloud process. The processor 210 executes the third point cloud process by executing the second program 232.

The processor 210 executes the same processes of S310 to S370 as in the embodiment of FIG. 8. Thereby, the processor 210 generates the target orientation parameter MPt.

In S410, the processor 210 projects the model point cloud PCm (that is, the reference object OBm) from the model coordinate system to the scene coordinate system according to the target orientation parameter MPt. The projected reference object OBm roughly matches one target object OB represented by the scene point cloud PCs. The processor 210 selects point pairs that satisfy the pair condition from a plurality of points PT of the projected reference object OBm. In this embodiment, the model key table Km (FIG. 7A) indicates a plurality of point pairs selected from the reference object OBm before projection (that is, the model point cloud PCm). The processor 210 may select the same point pairs as the point pairs indicated by the model key table Km, from the plurality of points PT of the projected reference object OBm. For example, the processor 210 assigns a point identifier to each of the plurality of points PT of the model point cloud PCm. The processor 210 selects the same point pairs by referring to the point identifier.

In S420, the processor 210 calculates a feature for each of the plurality of point pairs selected in S410. In this embodiment, the processor 210 calculates two normal vectors vPn1 and vPn2 of the first point P (FIG. 6A) and two normal vectors vQn1 and vQn2 of the second point Q. Then, the processor 210 calculates the angle formed by the two normal vectors as the feature (the angle is larger than or equal to 0 degrees and smaller than or equal to 180 degrees). The two normal vectors may be particular two normal vectors (for example, the normal vectors vPn1 and vPn2) among the four normal vectors vPn1, vPn2, vQn1, and vQn2. Further, the processor 210 may calculate the angle of two normal vectors (for example, the three angles S1, S2, and S3 described in FIGS. 6B to 6D) of each of particular N combinations (N is an integer greater than or equal to 1 and smaller than or equal to 6).

In S430, the processor 210 selects, as a small angle point pair, a point pair that satisfies a small angle condition indicating that the angle is small. In this embodiment, the small angle condition is that all of the N angles are smaller than or equal to a threshold TH. If one or more angles are greater than the threshold TH, the small angle condition is not satisfied.

FIGS. 11A and 11B are explanatory diagrams of the relationship between angles and surface shapes of a three-dimensional object. FIG. 11A shows a perspective view of a flat partial surface SF1 of the surface of the reference object OBm, and FIG. 11B shows a perspective view of a curved partial surface SF2 of the surface of the reference object OBm. The first point P, the spheres SP1, SP2, and the areas ARa, ARb are shown on the partial surfaces SF1 and SF2 of each figure. Each figure also shows the normal vectors vPn1 and vPn2. Grid-like dotted lines on the partial surfaces SF1 and SF2 are imaginary lines added to indicate the shape of the partial surfaces SF1 and SF2.

As shown in FIG. 11A, when the first point P is located on the flat partial surface SF1, the small area ARa and the large area ARb may be formed on the same flat partial surface SF1. In this case, an angle Ang1 formed by the first-type normal vector vPn1 and the second-type normal vector vPn2 is small.

As shown in FIG. 11B, when the first point P is located on the curved partial surface SF2, the large area ARb may include a partial surface facing in a direction different from that of the partial surface included in the small area ARa. For example, the partial surface within the small area ARa faces upward in the figure, while a partial surface SF2x included in the large area ARb faces upper right in the figure. In this case, an angle Ang2 formed by the first-type normal vector vPn1 and the second-type normal vector vPn2 is large.

As described above, when the angle formed by the two normal vectors vPn1 and vPn2 is small, it is highly likely that the point corresponding to the normal vector (here, the first point P) is located on the flat partial surface. The same is true for other combinations of two normal vectors. For example, when the angle formed by the normal vector vPn1 of the first point P and the normal vector vQn1 of the second point Q is small, it is highly likely that the two points P and Q are located on the same flat partial surface. When the angle formed by the two normal vectors is large, it is highly likely that one or two points corresponding to the two normal vectors are located on a curved partial surface.

The threshold TH of the angle is experimentally determined preliminarily such that a small angle point pair indicates a flat partial surface that is easily gripped by the plurality of fingers 126 of the robot arm 120. Further, a plurality of point pairs may satisfy the small angle condition. In this embodiment, the processor 210 compares the largest angle of the N angles (referred to as a characteristic angle) among the plurality of point pairs. The processor 210 then adopts one point pair having the smallest characteristic angle as the small angle point pair.

In S460 (FIG. 10), the processor 210 determines the position and orientation of the flat partial surface of the target object OB by using the small angle point pair. When the small angle point pair is located on the flat partial surface, the two normal vectors used to calculate the angle for determination of the small angle condition (S430) indicate the normal vector of the flat partial surface. The processor 210 adopts the position of a point corresponding to the two normal vectors (the first point P or the second point Q) as the position of the partial surface, and adopts either one of the two normal vectors as a direction perpendicular to the partial surface. The processor 210 controls the robot arm 120 such that one finger 126 (FIG. 1) contacts the partial surface determined in this way. The processor 210 then controls the robot arm 120 to cause the plurality of fingers 126 to grip the target object OB. The processor 210 then controls the robot arm 120 to move the gripped target object OB to a predetermined position. Then, the process of FIG. 10 ends. The processor 210 repeatedly executes the process of FIG. 10. Thereby, the processor 210 moves the plurality of target objects OB that are bulk-stacked on the tray 130 to the predetermined position one item at a time.

As described above, the processor 210 executes the following processes. In S410 of FIG. 10, the processor 210 selects a plurality of point pairs satisfying the pair condition from the plurality of points PT of the projected reference object OBm. In S420, the processor 210 determines the four normal vectors vPn1, vPn2, vQn1, and vQn2 for each of the plurality of point pairs. The processor 210 then calculates the feature for each of the plurality of point pairs. The feature includes the angle formed by two normal vectors selected from the four normal vectors vPn1, vPn2, vQn1, and vQn2. The processor 210 calculates the angle of two normal vectors of each of the N combinations. The processor 210 executes the particular process by using the calculated feature. The particular process includes S430 of FIG. 10. In S430, the processor 210 selects, from the plurality of point pairs, a small angle point pair that satisfies the small angle condition indicating that the angle is small. As described above, the small angle point pair indicates a flat partial surface of the target object OB. The flat partial surface may be used for various processes such as gripping the target object OB by the robot arm 120.

The processor 210 may use a plurality of point pairs that satisfy the small angle condition to determine the flat partial surface. For example, the processor 210 may calculate, as a flat partial surface, an approximate plane that approximates the plurality of points included in the plurality of point pairs. The method of calculating the approximate plane may be any method such as a method using principal component analysis.

The process of determining the target orientation parameter MPt may be any other process instead of the process of S310 to S370 (FIG. 8).

The processor 210 may determine the local coordinate system by using the small angle point pair. The local coordinate system may be used to calculate orientation parameters (for example, the orientation parameter MP in FIG. 9G) for conversion into various other coordinate systems.

The small angle condition may be various conditions indicating that the angle formed by two normal vectors is small. For example, the small angle condition may be that a representative angle calculated from N angles is smaller than or equal to the threshold TH (for example, the representative angle may be a value correlated with the N angles, such as an average value, a median value, a maximum value, and a minimum value).

### C. Third Embodiment

FIG. 12 is a flowchart showing another embodiment of a point cloud process. In a fourth point cloud process, characteristic point pairs are selected from the scene point cloud PCs. The processor 210 of the data processing apparatus 200 executes the fourth point cloud process according to a program (not shown).

The processes of S510, S520, S525 and S530 are the same as the processes of S310, S320, S325 and S330 of FIG. 8, respectively. The processor 210 generates the feature Fs, the scene key table Ks, and the scene hash table HTs by using the scene point cloud PCs. Note that, in this embodiment, the first point cloud process in FIG. 2 may be omitted. In S525, the processor 210 refers to the occurrence probability 36 of each key 33 (FIG. 7B) in the scene hash table HTs, and turns on the flag 37 corresponding to the occurrence probability 36 that satisfies the low ratio condition. In S530, the processor 210 refers to the flag 37 of the scene hash table HTs, and selects a characteristic scene point pair, which is a point pair corresponding to the characteristic key 33.

In S540, the processor 210 stores data indicating the characteristic scene point pairs selected in S530 in the memory 215 (for example, the non-volatile memory 230). In this embodiment, this data represents two points for each characteristic scene point pair. Then, the process of FIG. 12 ends. The data stored in S540 may be data indicating the scene hash table HTs. Alternatively, the processor 210 may store other data indicating the two points of each characteristic scene point pair in the non-volatile memory 230. The data indicating the two points of each characteristic scene point pair may be used in various processes. For example, in controlling the robot arm 120 such as the embodiments of FIGS. 8 and 10, the characteristic scene point pairs may be used as key points indicating the characteristics of the object.

As described above, the processor 210 executes the following processes. In S520, the processor 210 executes the processes of FIG. 4. In S230 of FIG. 4, the processor 210 selects a plurality of point pairs satisfying the pair condition from the scene point cloud PCs. In S240, the processor 210 determines the normal vectors vPn1, vPn2, vQn1, and vQn2 of each of the plurality of point pairs. The processor 210 then calculates the feature for each of the plurality of point pairs. The processor 210 executes the particular process by using the calculated feature. The particular process includes S525, S530, and S540 of FIG. 12. In S525, the processor 210 stores the plurality of features of the plurality of point pairs in the scene hash table HTs. Thereby, the plurality of features are classified into a plurality of categories. The processor 210 refers to the occurrence probability 36 of each key 33 (FIG. 7B) in the scene hash table HTs, and turns on the flag 37 corresponding to the occurrence probability 36 that satisfies the low ratio condition. The low ratio condition includes that the occurrence probability 36 is lower than or equal to the upper limit. The occurrence probability 36 indicates the ratio of the number of point pairs included in the category 33 to the total number of plurality of point pairs. In S530, the processor 210 selects both the first point and the second point of each point pair included in the category 33 that satisfies the low ratio condition. In S540, the processor 210 stores data indicating the selected points in the memory 215 (here, the non-volatile memory 230). In this manner, the processor 210 selects points of distinctive point pairs that fall within the category 33 that satisfies the low ratio condition. The selected points may be used for various operations, such as controlling the robot arm 120.

In S540, data indicating one point (the first point P or the second point Q) of each characteristic scene point pair may be stored.

### D. Fourth Embodiment

FIG. 13 is a flow chart showing another embodiment of a point cloud process. In a fifth point cloud process, S550 to S570 are added to the fourth point cloud process of FIG. 12.

The processes of S510 to S540 are the same as the processes of S510 to S540 of the embodiment of FIG. 12, respectively.

After S540, in S550, the processor 210 determines a local coordinate system by using the characteristic scene point pair selected in S530. The determination method of the local coordinate system is the same as the determination method of S356 in FIG. 8. The processor 210 determines three vectors vXLs, vYLs, and vZLs (that is, coordinate axes XLs, YLs, and ZLs) that define the local coordinate system by using the first point P and the second point Q of the characteristic scene point pair. In a case where a plurality of characteristic scene point pairs are selected, the processor 210 determines the local coordinate system for each characteristic scene point pair.

In S560, the processor 210 calculates the scene orientation parameter Ms by using the local coordinate system. The calculation method of the scene orientation parameter Ms is the same as the calculation method of S358 in FIG. 8. If a plurality of characteristic scene point pairs are selected, the processor 210 calculates the scene orientation parameter Ms for each characteristic scene point pair.

In S570, the processor 210 stores data indicating the local coordinate system and the scene orientation parameter Ms in the memory 215 (here, the non-volatile memory 230). Then, the process of FIG. 13 ends. The data indicating the local coordinate system and the scene orientation parameter Ms may be used for various processes. For example, there is a case where a partial surface to be measured by the three-dimensional sensor 110 among the surfaces of the target object OB is determined in advance. In this case, the position and orientation of the three-dimensional sensor 110 may be adjusted such that the partial surface to be measured is located in the measurement direction 110x of the three-dimensional sensor 110. Here, the local coordinate system may indicate the position and orientation of the target object OB relative to the three-dimensional sensor 110. Thus, by using the local coordinate system, the position and orientation of the three-dimensional sensor 110 is easily adjusted to the appropriate position and orientation. Here, the coordinates may be converted using the scene orientation parameter Ms.

In this way, the processor 210 executes the following processes. In S520 (FIG. 12), the processor 210 executes the process of FIG. 4. In S230 of FIG. 4, the processor 210 selects a plurality of point pairs satisfying the pair condition from the scene point cloud PCs. In S240, the processor 210 determines the normal vectors vPn1, vPn2, vQn1, and vQn2 of each of the plurality of point pairs. The processor 210 then calculates the feature for each of the plurality of point pairs.

The processor 210 executes the particular process using the calculated feature. The particular process includes S525, S530, and S540 of FIG. 12. In S525, the processor 210 stores the plurality of features of the plurality of point pairs in the scene hash table HTs. Thereby, the plurality of features are classified into a plurality of categories. The processor 210 refers to the occurrence probability 36 of each key 33 (FIG. 7B) in the scene hash table HTs, and turns on the flag 37 corresponding to the occurrence probability 36 that satisfies the low ratio condition. The low ratio condition includes that the occurrence probability 36 is lower than or equal to the upper limit. The occurrence probability 36 indicates the ratio of the number of point pairs included in the category 33 to the total number of plurality of point pairs. In S530, the processor 210 selects each point pair included in the category 33 that satisfies the low ratio condition (the selected point pair is referred to as a low rate point pair). In S550 (FIG. 13), the processor 210 determines the local coordinate system by using the low rate point pair. In S570, the processor 210 stores data indicating the local coordinate system in the memory.

As described with reference to FIGS. 9A to 9D and 9F, the process of determining the local coordinate system includes the process of calculating the three vectors vXLs, vYLs, and vZLs. The first vector vXLs is a vector that defines the first axis XLs. Similar to the first vector vXLm in FIGS. 9A and 9B, the first vector vXLs has a start point, which is the first point P, and an end point located on a straight line passing through the first point P and the second point Q. The third vector vZLs is a vector that defines the third axis ZLs. Similar to the third vector vZLm in FIG. 9C, the third vector vZLs is the cross product of the first-type normal vector vPn1 and the first vector vXLs. The second vector vYLs is a vector that defines the second axis YLs. Similar to the second vector vYLm in FIG. 9D, the second vector vYLs is the cross product of the first vector vXLs and the third vector vZLs.

In this way, the processor 210 determines the appropriate local coordinate system by using the point pair.

### E. Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described invention are provided below:
(1) The distance range from the points P and Q for calculating the normal vectors may be various other ranges instead of the ranges Ra and Rb described in FIGS. 5A to 5D. Here, the distance range for the first-type normal vector vPn1 of the first point P is referred to as a first distance range, and the distance range for the second-type normal vector vPn2 of the first point P is referred to as a second distance range, the distance range for the first-type normal vector vQn1 of the second point Q is referred to as a third distance range, and the distance range for the second-type normal vector vQn2 of the second point Q is referred to as a fourth distance range. In the above embodiment, the first distance range and the third distance range are the same small range Ra. Here, the first distance range may include a distance that is not included in the third distance range. The third distance range may include a distance that is not included in the first distance range. Thus, the first distance range may differ from the third distance range. The lower limit of the first distance range may be greater than zero. The lower limit of the third distance range may be greater than zero. In the above embodiment, the second distance range and the fourth distance range are the same large range Rb. Here, the second distance range may include a distance that is not included in the fourth distance range. The fourth distance range may include a distance that is not included in the second distance range. Thus, the second distance range may differ from the fourth distance range. The lower limit of the second distance range may be smaller than the upper limit of the first distance range. The lower limit of the fourth distance range may be smaller than the upper limit of the third distance range. In either case, the upper limit of the second distance range is preferably greater than the upper limit of the first distance range, and the upper limit of the fourth distance range is preferably greater than the upper limit of the third distance range.
(2) The selection conditions of S340 in FIG. 8 may be various conditions. For example, the selection condition may be that the average value of seven differences is smaller than or equal to an allowable threshold. The allowable threshold may be determined for each parameter. In general, the selection condition may be various conditions including that the feature of the characteristic model point pair and the feature of the characteristic scene point pair match or are similar to each other. Further, the selection condition may include that the additional feature of the characteristic model point pair and the additional feature of the characteristic scene point pair match or are similar to each other.
(3) The feature of the point pair (that is, the feature indicating the geometric feature of the shape of an object) may consist of one or more parameters arbitrarily selected from the three parameters S1, S2 and S3 described with reference to FIGS. 6A to 6D.
(4) The additional feature of the point pair (that is, the feature indicating the geometric feature of the shape of an object) may consist of one or more parameters arbitrarily selected from the four parameters Sa1 to Sa4 described with reference to FIGS. 6E to 6H. The additional feature may include other various parameters. For example, the additional feature may include so-called SHOT feature (SHOT is an abbreviation of Signature of Histograms of OrienTations). The additional feature may be omitted. For example, in S340 of FIG. 8, a particular combination may be selected without using the additional feature.
(5) The low ratio conditions used in S125, S130 (FIG. 2), S525, S530 (FIG. 12), and so on, may be various conditions, including that the occurrence probability 36 is lower than or equal to the upper limit. For example, the low ratio condition may be that the occurrence probability 36 may be in a range higher than or equal to zero and lower than or equal to an upper limit.
(6) The method of selecting a distinctive point pair may be various other methods instead of the method of selecting a point pair that satisfies the low ratio condition. For example, the method of selecting key points disclosed in Japanese Patent Application Publication No. 2018-189510 may be employed.
(7) The method of determining the local coordinate system may be various other methods instead of the method described with reference to FIGS. 9A to 9D. For example, in the calculation formula of FIG. 9C, the second-type normal vector vPn2 may be used in place of the first-type normal vector vPn1.

The processor 210 may determine the local coordinate system by using the coordinates of the first point P, the coordinates of the second point Q, and one normal vector of the first point P or the second point Q. The processor 210 may perform the following processes as the process of determining the local coordinate system.
(a) Point pair selection process of selecting a point pair of a first point and a second point separated by a distance within a particular distance range from a three-dimensional point cloud containing a plurality of points representing the surface of a three-dimensional object (for example, S230 in FIG. 4).
(b) First determination process of determining a first normal vector at a first point by using a plurality of points included in a first area whose distance from the first point is within a first distance range (for example, a process of determining one normal vector among the processes of determining the four normal vectors vPn1, vPn2, vQn1, and vQn2 in S240 in FIG. 4).
(c) Determination process of determining a local coordinate system having a first axis, a second axis, and a third axis that are perpendicular to one another by using the first point, the second point, and the first normal vector (for example, a process similar to S352 in FIG. 8).

Here, the determination process of determining the local coordinate system includes the following processes.
(c1) A process of calculating a first vector defining the first axis, the first vector having a start point which is the first point and an end point located on a straight line passing through the first point and the second point.
(c2) A process of calculating a third vector that defines the third axis, the third vector being the cross product of the first normal vector and the first vector or the cross product of the second normal vector and the first vector.
(c3) A process of calculating a second vector that defines the second axis, the second vector being the cross product of the first vector and the third vector.
(8) The method of calculating the normal vector perpendicular to the approximate plane that approximates a plurality of points is not limited to the method using principal component analysis, and various other methods may be used. For example, the processor 210 may determine an approximate plane that approximates a plurality of points according to the so-called least-squares method. The processor 210 may then calculate a normal vector based on the determined plane.
(9) Various methods may be used for performing matching between the model coordinate system and the scene coordinate system instead of the method described with reference to FIGS. 9A to 9H. For example, the following method may be adopted.

Translate the first point P of the model point pair and the first point P of the scene point pair to the origin. Align the normal of each point pair with the X axis. Rotate the model point pair around the X axis until the model point pair matches the scene point pair. Determine a coordinate transformation formula according to these operations. The details of this method are disclosed in Japanese Patent Application Publication No. 2018-189510.
(10) The process of using the point cloud may be various other processes instead of the process of the above embodiment and modification. For example, in S530 of FIG. 12, the processor 210 may select one point (the first point P or the second point Q) of each point pair. In S540, the processor 210 may store data indicating the selected point in the memory. The point cloud process of FIG. 12 and the point cloud process of FIG. 13 may be performed on the model point cloud PCm. The processor 210 may also cause the robot arm 120 to perform a task of assembling the target object OB to another part. For example, the target object OB may be inserted into a recess of another part.
(11) The configuration of the robot arm 120 is not limited to the configuration described with reference to FIG. 1, and may be any other configuration. For example, the tip end portion of the robot arm 120 (also called an end effector) may have a sucker for sucking an object instead of the fingers 126. The processor 210 may cause the sucker to be pressed against a flat surface of an object to move the object.
(12) The configuration of the point cloud processing apparatus for processing the point cloud may be various other configurations instead of the configuration of the data processing apparatus 200 shown in FIG. 1. For example, a plurality of apparatuses (for example, computers) that communicate with each other via a network may share a part of the data processing function of the point cloud processing apparatus and provide the point cloud processing function as a whole (a system including these apparatuses serves as the point cloud processing apparatus).

In each of the above embodiments, part of the configuration implemented by hardware may be replaced with software, and conversely, part or all of the configuration implemented by software may be replaced with hardware. For example, the function of calculating the feature in FIG. 4 may be realized by a dedicated hardware circuit.

In a case where part or all of the functions of the present disclosure are realized by a computer program, the program may be provided in a form of being stored in a computer-readable storage medium (for example, a non-transitory storage medium). The program may be used in a state where the program is stored in the same storage medium (computer-readable storage medium) as when the program was provided, or in a storage medium different from when the program was provided. The “computer-readable storage medium” is not limited to portable recording media such as a memory card and a CD-ROM, but also includes an internal memory in a computer such as various ROMs, and an external memory connected to a computer such as a hard disk drive.

What is claimed is:

1. A non-transitory computer-readable storage medium storing a set of program instructions for a computer, the set of program instructions, when executed by a controller of the computer, causing the computer to perform:
selecting a point pair of a first point and a second point from a three-dimensional point cloud including a plurality of points indicating a surface of a three-dimensional object, the first point and the second point being separated by a distance within a particular distance range;
determining a first normal vector at the first point by using a plurality of points included in a first area of which a distance from the first point is within a first distance range;
determining a second normal vector at the first point by using a plurality of points included in a second area of which a distance from the first point is within a second distance range, the second distance range including a distance greater than an upper limit of the first distance range;
determining a third normal vector at the second point by using a plurality of points included in a third area of which a distance from the second point is within a third distance range;
determining a fourth normal vector at the second point by using a plurality of points included in a fourth area of which a distance from the second point is within a fourth distance range, the fourth distance range including a distance greater than an upper limit of the third distance range;
calculating a feature indicating a geometric feature by using the first normal vector, the second normal vector, the third normal vector, and the fourth normal vector; and
performing a particular process by using the feature.

2. The non-transitory computer-readable storage medium according to claim 1, wherein a lower limit of the second distance range is greater than or equal to the upper limit of the first distance range.

3. The non-transitory computer-readable storage medium according to claim 1, wherein a lower limit of the fourth distance range is greater than or equal to the upper limit of the third distance range.

4. The non-transitory computer-readable storage medium according to claim 1, wherein one or both of a first condition and a second condition is satisfied, the first condition being that the first distance range is same as the third distance range, the second condition being that the second distance range is same as the fourth distance range.

5. The non-transitory computer-readable storage medium according to claim 1, wherein the selecting the point pair includes:
selecting a plurality of first-type point pairs from a first three-dimensional point cloud that is generated by measuring a space containing a first three-dimensional object by a three-dimensional sensor, the plurality of first-type point pairs being a plurality of point pairs of the first point and the second point; and
selecting a plurality of second-type point pairs from a second three-dimensional point cloud containing a plurality of points indicating a surface of a second three-dimensional object that is a reference three-dimensional object, the plurality of second-type point pairs being a plurality of point pairs of the first point and the second point;
wherein the determining the first normal vector includes:
determining the first normal vector of each of the plurality of first-type point pairs; and
determining the first normal vector of each of the plurality of second-type point pairs;
wherein the determining the second normal vector includes:
determining the second normal vector of each of the plurality of first-type point pairs; and
determining the second normal vector of each of the plurality of second-type point pairs;
wherein the determining the third normal vector includes:
determining the third normal vector of each of the plurality of first-type point pairs; and
determining the third normal vector of each of the plurality of second-type point pairs;
wherein the determining the fourth normal vector includes:
determining the fourth normal vector of each of the plurality of first-type point pairs; and
determining the fourth normal vector of each of the plurality of second-type point pairs;
wherein the calculating the feature includes:
calculating a first-type feature that is the feature of each of the plurality of first-type point pairs; and
calculating a second-type feature that is the feature of each of the plurality of second-type point pairs; and
wherein the particular process includes selecting particular combinations, each of the particular combinations being a combination of a first-type point pair and a second-type point pair satisfying a selection condition, the selection condition including that the first-type feature and the second-type feature match or are similar to each other, the first-type point pair being one of the plurality of first-type point pairs, the second-type point pair being one of the plurality of second-type point pairs.

6. The non-transitory computer-readable storage medium according to claim 5, wherein the particular process includes:
classifying a plurality of first-type features of the plurality of first-type point pairs into a plurality of categories; and
classifying a plurality of second-type feature of the plurality of second-type point pairs into the plurality of categories; and
wherein the selecting the particular combinations includes selecting the particular combinations from combinations of the first-type point pair and the second-type point pair included in a same category satisfying a low ratio condition, the low ratio condition including that a ratio of a number of the second-type point pair included in a category to a total number of the plurality of second-type point pairs is smaller than or equal to an upper limit.

7. The non-transitory computer-readable storage medium according to claim 6, wherein the set of program instructions, when executed by the controller, causes the computer to further perform:
calculating an additional feature indicating a geometric feature by using the first point and the second point in addition to the first normal vector, the second normal vector, the third normal vector, and the fourth normal vector;
wherein the calculating the additional feature includes:
calculating a first-type additional feature that is the additional feature of each of the plurality of first-type point pairs; and
calculating a second-type additional feature that is the additional feature of each of the plurality of second-type point pairs; and
wherein the selection condition includes the first-type additional feature and the second-type additional feature match or are similar to each other.

8. The non-transitory computer-readable storage medium according to claim 5, wherein the particular process includes:
determining a local coordinate system by using a particular point pair, the local coordinate system having a first axis, a second axis, and a third axis perpendicular to one another, the particular point pair being the first-type point pair or the second-type point pair that forms the particular combinations; and
wherein the determining the local coordinate system includes:
calculating a first vector defining the first axis, the first vector having a start point that is the first point and an end point located on a straight line passing through the first point and the second point;
calculating a third vector defining the third axis, the third vector being a cross product of the first normal vector and the first vector or a cross product of the second normal vector and the first vector; and
calculating a second vector defining the second axis, the second vector being a cross product of the first vector and the third vector.

9. The non-transitory computer-readable storage medium according to claim 1, wherein the selecting the point pair includes selecting a plurality of point pairs of the first point and the second point from the three-dimensional point cloud;
wherein the determining the first normal vector includes determining the first normal vector of each of the plurality of point pairs;
wherein the determining the second normal vector includes determining the second normal vector of each of the plurality of point pairs;
wherein the determining the third normal vector includes determining the third normal vector of each of the plurality of point pairs;
wherein the determining the fourth normal vector includes determining the fourth normal vector of each of the plurality of point pairs;
wherein the calculating the feature includes calculating the feature of each of the plurality of point pairs;
wherein the feature includes an angle formed by two normal vectors selected from the first normal vector, the second normal vector, the third normal vector, and the fourth normal vector; and
wherein the particular process includes selecting a small angle point pair from the plurality of point pairs, the small angle point pair satisfying a small angle condition indicating that the angle is small.

10. The non-transitory computer-readable storage medium according to claim 1, wherein the selecting the point pair includes selecting a plurality of point pairs of the first point and the second point from the three-dimensional point cloud;
wherein the determining the first normal vector includes determining the first normal vector of each of the plurality of point pairs;
wherein the determining the second normal vector includes determining the second normal vector of each of the plurality of point pairs;
wherein the determining the third normal vector includes determining the third normal vector of each of the plurality of point pairs;
wherein the determining the fourth normal vector includes determining the fourth normal vector of each of the plurality of point pairs;
wherein the calculating the feature includes calculating the feature of each of the plurality of point pairs;
wherein the particular process includes:
classifying a plurality of features of the plurality of point pairs into a plurality of categories;
selecting one or both of the first point and the second point of a point pair included in a category satisfying a low ratio condition, the low ratio condition including that a ratio of a number of the point pair included in the category to a total number of the plurality of point pairs is smaller than or equal to an upper limit; and
storing data indicating a selected point in a memory.

11. The non-transitory computer-readable storage medium according to claim 1, wherein the selecting the point pair includes selecting a plurality of point pairs of the first point and the second point from the three-dimensional point cloud;
wherein the determining the first normal vector includes determining the first normal vector of each of the plurality of point pairs;
wherein the determining the second normal vector includes determining the second normal vector of each of the plurality of point pairs;
wherein the determining the third normal vector includes determining the third normal vector of each of the plurality of point pairs;
wherein the determining the fourth normal vector includes determining the fourth normal vector of each of the plurality of point pairs;
wherein the calculating the feature includes calculating the feature of each of the plurality of point pairs;
wherein the particular process includes:
classifying a plurality of features of the plurality of point pairs into a plurality of categories;
selecting a low rate point pair included in a category satisfying a low ratio condition, the low ratio condition including that a ratio of a number of the point pair included in the category to a total number of the plurality of point pairs is smaller than or equal to an upper limit;
determining a local coordinate system by using the low rate point pair; and
storing data indicating the local coordinate system in a memory; and
wherein the determining the local coordinate system includes:
calculating a first vector defining a first axis, the first vector having a start point that is the first point and an end point located on a straight line passing through the first point and the second point;
calculating a third vector defining a third axis, the third vector being a cross product of the first normal vector and the first vector or a cross product of the second normal vector and the first vector; and
calculating a second vector defining a second axis, the second vector being a cross product of the first vector and the third vector.

12. The non-transitory computer-readable storage medium according to claim 6, wherein the particular process further includes:
calculating a candidate orientation parameter of each of the particular combinations, the candidate orientation parameter being a parameter that projects a coordinate system of the second three-dimensional point cloud onto a coordinate system of the first three-dimensional point cloud such that a local coordinate system of the second-type point pair of the combination satisfying the selection condition is projected onto a local coordinate system of the first-type point pair of the combination satisfying the selection condition;
calculating an evaluation value of the candidate orientation parameter of each of the particular combinations to select a best evaluation value; and
controlling a robot arm by using the candidate orientation parameter having the best evaluation value.

13. The non-transitory computer-readable storage medium according to claim 1, wherein the three-dimensional point cloud includes:
a model point cloud including a plurality of points indicating a surface of a reference object; and
a scene point cloud including a plurality of points that is generated by measuring a space containing a target object by a three-dimensional sensor; and
wherein the particular process includes:
performing matching between the reference object and the target object by using the feature calculated for the point pair of the model point cloud and the feature calculated for the point pair of the scene point cloud;
determining a position and an orientation of the target object based on the matching; and
controlling a robot arm by using the position and the orientation of the target object.

14. A point cloud processing apparatus comprising:
an interface;
a memory; and
a controller configured to perform:
acquiring data indicating a three-dimensional point cloud through the interface or from the memory, the three-dimensional point cloud including a plurality of points indicating a surface of a three-dimensional object;
selecting a point pair of a first point and a second point from the three-dimensional point cloud, the first point and the second point being separated by a distance within a particular distance range;
determining a first normal vector at the first point by using a plurality of points included in a first area of which a distance from the first point is within a first distance range;
determining a second normal vector at the first point by using a plurality of points included in a second area of which a distance from the first point is within a second distance range, the second distance range including a distance greater than an upper limit of the first distance range;
determining a third normal vector at the second point by using a plurality of points included in a third area of which a distance from the second point is within a third distance range;
determining a fourth normal vector at the second point by using a plurality of points included in a fourth area of which a distance from the second point is within a fourth distance range, the fourth distance range including a distance greater than an upper limit of the third distance range;
calculating a feature indicating a geometric feature by using the first normal vector, the second normal vector, the third normal vector, and the fourth normal vector; and
performing a particular process by using the feature.
